(19) United States
(12) Patent Application Publication
(10) Pub. No.: US 2016/0343503 A1
(43) Pub. Date: Nov. 24, 2016

(54) Transformer

(71) Applicant: HITACHI INDUSTRIAL EQUIPMENT SYSTEMS CO., LTD., Tokyo (JP)

(72) Inventors: Shohei UENO, Tokyo (JP); Tatsunori SATO, Tokyo (JP); Shuji TADA, Tokyo (JP); Makoto SHINOHARA, Tokyo (JP)

(21) Appl. No.: 15/115,024

(22) PCT Filed: Apr. 16, 2014
(86) PCT No.: PCT/JP2014/060768

§ 371 Date: Jul. 28, 2016

(51) Int. Cl. H01F 30/08

(52) U.S. Cl. CPC H01F 30/08

(57) ABSTRACT

A transformer comprises at least a wound iron core, a lower portion clamp disposed at the lower portion of the wound iron core, and band for fastening the wound iron core and the lower portion clamp to each other. In the transformer, the lower portion clamp has a flat plate portion that supports the lower portion of the wound iron core and a bent portion that extends from the flat plate portion toward the outer periphery side of the wound iron core and upward. The end of the bent portion on the outer periphery side of the wound iron core extends to substantially the outer periphery of the wound iron core or to an outer side than the outer periphery of the wound iron core. The band fastens and fixes the wound iron core and the lower portion clamp to each other along the flat plate portion and bent portion of the lower portion clamp. This prevents the characteristics of the iron core from being deteriorated due to a compressive load applied to the iron core by the fastening of the band.

### TECHNICAL FIELD

The present invention relates to a transformer.

### BACKGROUND ART

As background art of the present technical field, there is JP-A-2006-294673 (Patent Literature 1). This publication describes, as a solution to problem, “a transformer content support device including: inserting an iron core 1 into a coil 2; then arranging a lower clamp 5 supporting the iron core 1 and an upper clamp 4 provided above the iron core 1; then inserting an iron-made band 6 into between the iron core 1 and the coil 2 and causing the iron-made band 6 to pass through band insertion holes (17a, 17b, 18a, and 18b) provided in the upper clamp 4 and the lower clamp 5; and then fastening the iron-made band 6, wherein support plates 7 are inserted into side surfaces of the iron core 1 between the iron core 1 inserted in the coil 2 and the coil 2, the support plates 7 having a length dimension approximately the same as or longer than an iron core height of the iron core 1, and the upper clamp 4, the lower clamp 5, and the support plates 7 form a box shape at the time of fastening the iron-made band.” and as a technical problem, “a transformer content support device that can reduces a compressive load applied to an iron core at the time of fastening a band is obtained”. (See ABSTRACT.)

### CITATION LIST

### Patent Literature

### PATENT LITERATURE 1: JP-A-2006-294673

### SUMMARY OF INVENTION

### Technical Problem

A compressive load is applied to an iron core by fastening of a band, and characteristics of the iron core are deteriorated.

### Solution to Problem

To solve the problem, the configuration described in CLAIMS is employed, for example. The present application includes a plurality of solutions to the problem, and examples of the solutions include “a transformer including at least a wound iron core, a lower fitting arranged at a lower portion of the wound iron core, and a band adapted to fasten the wound iron core and the lower fitting, the lower fitting including a flat plate portion adapted to support the lower portion of the wound iron core, and a bent portion extending from the flat plate portion to an outer periphery side of the wound iron core and upward, an end portion of the bent portion at a side of the outer periphery of the wound iron core extending up to a position equivalent to the outer periphery of the wound iron core or up to outside of the outer periphery, and the band fastening and fixing the wound iron core and the lower fitting along the flat plate portion and the bent portion of the lower fitting”.

### ADVANTAGEOUS EFFECTS OF INVENTION

A transformer where characteristics of an iron core are not deteriorated even if the band is fastened is provided.

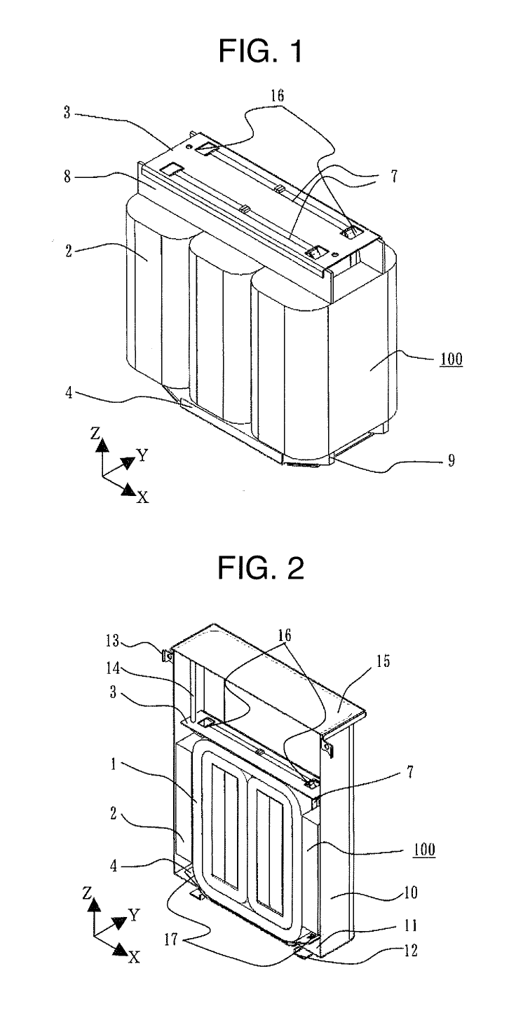

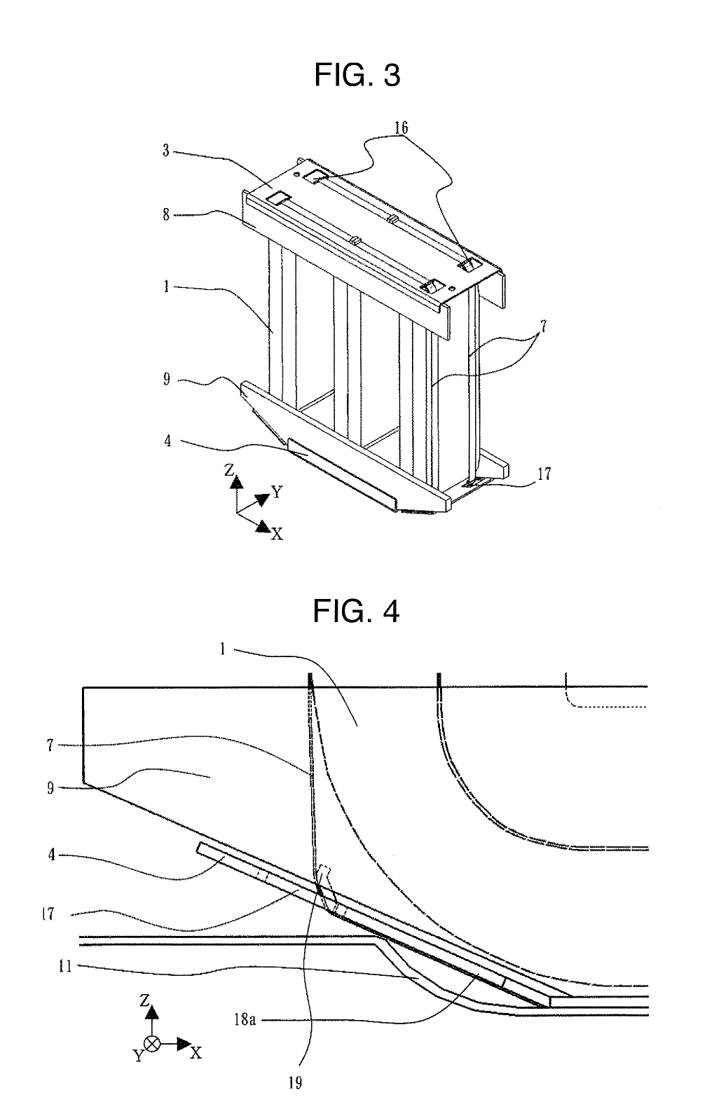

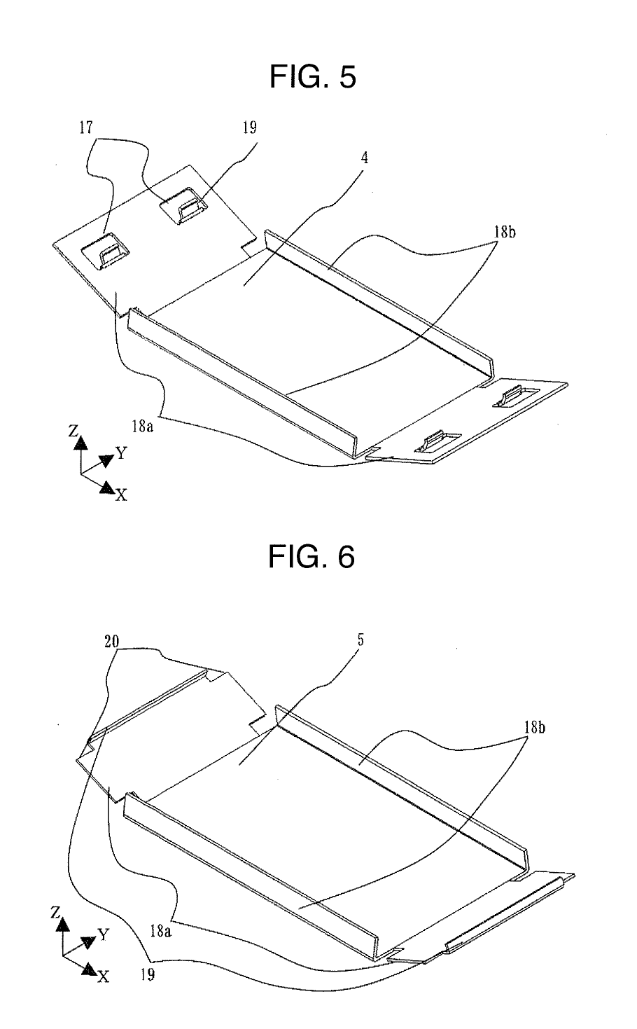

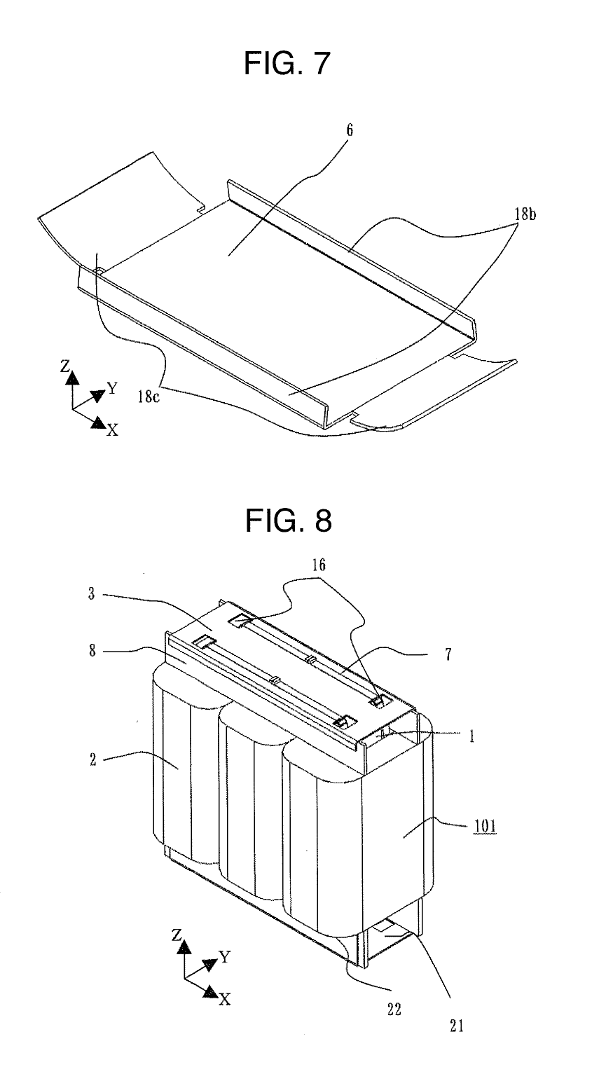

### BRIEF DESCRIPTION OF DRAWINGS

[FIG. 1] FIG. 1 is a perspective view of transformer content according to a first embodiment of the present invention.

[FIG. 2] FIG. 2 is a perspective sectional view of a transformer according to the first embodiment of the present invention.

[FIG. 3] FIG. 3 is a perspective view of a band fastening structure according to the first embodiment of the present invention.

[FIG. 4] FIG. 4 is an enlarged view of a contact surface of a lower fitting and a band according to the first embodiment of the present invention.

[FIG. 5] FIG. 5 is a perspective view of the lower fitting according to the first embodiment.

[FIG. 6] FIG. 6 is a perspective view of a lower fitting according to a second embodiment.

[FIG. 7] FIG. 7 is a perspective view of a lower fitting according to a third embodiment.

[FIG. 8] FIG. 8 is a perspective view of conventional transformer content.

### DESCRIPTION OF EMBODIMENTS

Hereinafter, embodiments of the present invention will be described using the drawings.

### First Embodiment

FIG. 8 is a perspective view of conventional transformer content. Transformer content 101 includes a wound iron core 1 and a coil 2 wound around the wound iron core 1. An upper fitting 3 is arranged above the wound iron core 1 and the coil 2, and a lower fitting 21 is arranged at a position facing the upper fitting 3 across the wound iron core 1 and the coil 2. An upper coil support 8 is arranged between the coil 2 and the upper fitting 3, and a lower coil support 22 is arranged between the coil 2 and the lower fitting 21. Further, the wound iron core 1, the upper fitting 3, and the lower fitting 21 are fixed by an iron-made band 7. The wound iron core, the upper fitting 3, and the lower fitting 21 are fastened by the band 7 extending in an X axis direction, and the band 7 fastens the wound iron core 1, the upper fitting 3, and the lower fitting 21 in a state where the band 7 is directly in contact with the wound iron core 1 at corner portions of the wound iron core 1. Therefore, there is a problem that, in a case of employing, as a material for the iron core, an amorphous material susceptible to compressive stress, characteristics of the wound iron core become deteriorated by stress that the iron core receives from the band. Further, the lower fitting 21 is a flat plate member, and in a case of configuring the lower fitting 21 from a plate member having a thin plate thickness, a vicinity of a region of the lower fitting 21, the region being fastened by the band, may be deformed and depressed along the X axis direction. Further, since the lower fitting 21 and the lower coil support 22 are not fixed in the X axis direction, the coil support 22 may be shifted in a case where shake occurs in the X axis direction, such as an earthquake.

FIG. 1 illustrates a perspective view of transformer content of the present invention. Transformer content 100 includes a wound iron core 1 and a coil 2 wound around and attached to the wound iron core 1. An upper fitting 3 is arranged above the wound iron core 1 and the coil 2, and a lower fitting 4 is arranged at a position facing the upper fitting 3 across the wound iron core 1 and the coil 2. An upper coil support 8 is arranged between the coil 2 and the upper fitting 3, and a lower coil support 9 is arranged between the coil 2 and the lower fitting 4. Further, the wound iron core 1, the upper fitting 3, and the lower fitting 4 are fixed by iron-made bands 7. This upper coil support 8 prevents direct application of stress to the wound iron core 1 when the wound iron core 1 is fastened by the bands 7. When the transformer content 100 is arranged on the lower fitting 4, stress by own weight of the transformer content 100 is applied to the iron core, and characteristics are deteriorated. To prevent the deterioration, the present invention has a structure in which the lower coil support 9 supports the coil 2 at a high position, and contact of the wound iron core 1 and the lower fitting 9 is avoided.

FIG. 2 illustrates a perspective sectional view of the transformer of the present embodiment. The bands 7 fasten and fix the wound iron core 1, the upper fitting 3, and the lower fitting 4 through band insertion holes 16 provided in the upper fitting 3 and band insertion holes 17 provided in the lower fitting 4. The wound iron core 1, the upper fitting 3, and the lower fitting 4 fastened and fixed by the bands are wound by the coil 2 and is further fixed to a tank 10 with a stud bolt 14. The tank 10 includes a bottom plate 11 that configures a lower portion of the tank and bases 12 welded to the bottom plate 11 and fixed to a bottom surface. A cover 15 that covers the entire transformer content is arranged on an upper surface of the tank.

FIG. 3 is a perspective view of the transformer content from which the coil is removed, in order to illustrate positional relationship among the wound iron core 1, the upper fitting 3, and the lower fitting 9, and the bands 7 of the present embodiment. As described in FIG. 2, the band 7 is inserted from the band insertion hole 16 provided in the upper fitting 3, passes through between the wound iron core 1 and the coil 2, is inserted into the band insertion hole 17 provided in the lower fitting 4, goes along the bottom surface of the lower fitting 4, passes through the insertion holes 16 and 17 of the upper and lower fittings at the opposite side, and is fastened and caulked at tan upper surface of the upper fitting 3. FIG. 4 is an enlarged diagram of a contact surface of the lower fitting 4 and the band 7 of the present embodiment. As the band 7, an iron-made band can be used, for example. When the band 7 is strongly fastened, force in a Z axis direction is applied to the lower fitting 4 by fastening force of the band 7, and thus the lower fitting 4 may have bending deformation. However, in the present embodiment, a part of the lower fitting 4 is arranged in contact with and along the lower coil support 9. Therefore, deformation of the lower fitting 4 can be prevented. Accordingly, fastening stress of the bands is prevented from acting on the wound iron core 1 through the lower fitting 4. In a case of employing this structure, the deformation can be suppressed by a structural method. Therefore, the plate thickness of the lower fitting 4 can be made thin to the extent that the lower fitting 4 is deformed by the fastening of the bands 7.

Further, as to prevention of shift of the wound iron core 1 in the X axis direction in a case where shake such as an earthquake occurs in the X direction, the lower fitting 4 is not simply a flat plate along a lower surface of the wound iron core 1 and does include bent portions 18a in the present embodiment, and thus can support the wound iron core 1 and the lower coil support 9 not only in a Y axis direction but also in the X axis direction. Accordingly, the wound iron core 1 can be fixed without being applied large stress when an earthquake occurs, and shake resistance is improved.

Further, the lower fitting 4 includes the bent portions 18a, and thus the transformer content 100 can be housed even if the bottom plate 11 of the tank 10 has a pressed-out portion. Pressing-out molding is applied to the bottom plate 11 and the transformer content is dropped into the tank 10 as described above, so that the transformer as a whole can have a low center of gravity. Further, the bottom plate 11 has a shape along the shape of the wound iron core 1, so that the bottom plate 11 can have a function to suppress the shake of the wound iron core 1 in the X axis direction, whereby improvement of shake resistance can be achieved.

FIG. 5 is a perspective view of the lower fitting according to the present embodiment. A part of the lower fitting 4 includes the bent portions 18a, and as described above, even the transformer having the bottom plate 11 formed by pressing-out molding can house the transformer content. Further, the insertion holes 17 are applied to the bent portion 18a and band contact portions 19 are provided so that the bands 7 do not come in contact with a corner of the lower fitting and do not destroy the lower fitting when the bands are fastened, and the bands 7 go along the band contact portions 19. Further, bent portions 18b are formed, and sandwich the wound iron core 1 and the lower coil support 9, so that the lower fitting has a structure having resistance to shake in a direction of end surfaces of the iron core (in the Y axis direction). In the conventional structure, only the bent portions 18b are formed, and thus the bent portions 18b are required to have a certain length to support the lower coil support 9. However, by formation of the bent portions 18a, the bent portions 18a support the coil support even in the X axis direction, and can suppress falling down in the Y axis direction. Therefore, the length of the bent portions 18b can be made short, which is led to reduction of material cost. Further, in the conventional transformer, the lower fitting is flat, and thus when the plate thickness of the fitting is small, the fitting is deformed in the Y axis direction by fastening of the bands. Further, nonuniform load is applied to the coil support, and pressing against the end surfaces of the iron core becomes weak. However, in the present embodiment, because the bent portions 18a are included in a part of the fitting, rigidity is enhanced and the fitting is less easily deformed even if the fitting receives the fastening force of the bands. Therefore, the coil support can be uniformly fastened. As a result, the bent portions 18b are opened outward, and deterioration of the characteristics by deformation of the shape of the iron core can be prevented.

### Second Embodiment

FIG. 6 is a perspective view of a lower fitting in a second embodiment of the present invention. In the present embodiment, an example of a structure of a lower fitting without using a special mold will be described. Description of members having the same reference signs and functions as the configurations illustrated in FIGS. 1 to 5 is omitted.

In the first embodiment, the band insertion holes 17 are formed in the bent portions 18a, and the band contact portions 19 are provided in the band insertion holes 17. However, the present embodiment is different in that band contact portions 19 are formed in outsides of bent portions 18a. The band contact portion 19 has a structure formed outside a corner portion of an iron core in an X axis direction so as not to apply a compressive load to a wound iron core 1. Further, notches 20 are formed in parts of the bent portion 18a, and thus integration can be performed even if a gap between a coil support 9 and a lower fitting 5 is small. Further, by formation of the band contact portions 19, strength of the lower fitting 5 as a whole against bending stress in the Y axis direction is further strengthened, compared with the lower fitting 4 of the first embodiment, and thus deformation in the Y axis direction by fastening of the bands can be suppressed. The lower fitting 5 of the present embodiment does not have insertion holes, unlike the first embodiment, and thus can be manufactured without a special mold.

### Third Embodiment

FIG. 7 is an example of a perspective view of a lower fitting in a third embodiment of the present invention. In the present embodiment, an example of a structure of a lower fitting with bent portions 18c having an arc shape along an iron core corner portion will be described.

In a lower fitting 6 of the third embodiment, the bent portion 18a is formed along a corner portion of an iron core. By adjusting a bend R such that a band is not in contact with a corner of a tip of the bent portion 18a, a structure not to apply a compressive load to the corner portion of the iron core without forming the band insertion holes and the band contact portions of the first and second embodiments becomes possible. Further, by adjusting the bend R along a curve R of the corner portion of the iron core, deformation of the shape of the iron core at the time of transportation can be suppressed. Further, by having the bend R close to a pressed-out portion of a bottom plate, shake in contact with the bottom plate can be adjusted to be smaller even if the transformer content vibrates at the time of transportation.

Description has been made on an embodiment-by-embodiment basis. However, the configurations of the embodiments can be combined and implemented.

### REFERENCE SIGNS LIST

100 Transformer content
101 Transformer content (conventional structure)
1 Wound iron core
2 Coil
3 Upper fitting
4 Lower fitting
5 Lower fitting
6 Lower fitting
7 Band
8 Upper coil support
9 Lower coil support
10 Tank
11 Bottom plate
12 Base
13 Hanging tool
14 Stud bolt
15 Cover
16 Band insertion hole
17 Band insertion hole
18a Bent portion
18b Bent portion
18c Bent portion
19 Band contact portion
20 Notch
21 Lower fitting of conventional structure
22 Lower coil support of conventional structure

1. A transformer comprising at least a wound iron core, a lower fitting arranged at a lower portion of the wound iron core, and a band adapted to fasten the wound iron core and the lower fitting, wherein:
the lower fitting includes a flat plate portion adapted to support the lower portion of the wound iron core and a bent portion extending from the flat plate portion to an outer periphery side and upward the wound iron core,
an end portion of the bent portion at the outer periphery side of the wound iron core extends up to a position equivalent to the outer periphery of the wound iron core or outside of the outer periphery, and
the band fastens and fixes the wound iron core and the lower fitting along the flat plate portion and the bent portion of the lower fitting.

2. The transformer according to claim 1, wherein
the lower fitting includes a band contact portion that is obtained by bending a part of the bent portion.

3. The transformer according to claim 2, wherein
the bent portion includes, in a part of the bent portion, a hole that allows the band to penetrate, and includes the band contact portion in the hole at an inner periphery side of the wound iron core.

4. The transformer according to claim 2, wherein
the band contact portion is included in the bent portion at an outermost periphery side of the wound iron core.

5. The transformer according to claim 1, wherein
the lower fitting includes the bent portion bent from the flat plate portion in a direction along an end surface of the wound iron core in an axis direction.

6. The transformer according to claim 1, wherein
the lower fitting includes a notch in a part of the bent portion at the outer periphery side of the wound iron core.

7. The transformer according to claim 1, wherein
the bent portion has a curved shape.

8. The transformer according to claim 1, further comprising:
a coil; and
a coil support adapted to support the coil between the lower fitting and the coil.
